(19) United States
(12) Patent Application Publication
(10) Pub. No.: US 2004/0093154 A1
(43) Pub. Date: May 13, 2004

(54) System and method of providing environmental context information for vehicle

(76) Inventors: Craig John Simonds, Dearborn, MI (US); John Loring Yester, Bloomfield Hills, MI (US); Krishnaswamy Venkatesh Prasad, Ann Arbor, MI (US)

Correspondence Address: PRICE, HENEVELD, COOPER, DEWITT & LITTON, 695 KENMOOR S.E., P. O. BOX 2567, GRAND RAPIDS, MI, 49501-2567, US

(21) Appl. No.: 10/696,078

(22) Filed: Oct. 29, 2003

Related U.S. Application Data
(60) Provisional application No. 60/425,526, filed on Nov. 12, 2002.

(51) Int. Cl. G01C 21/26

(52) U.S. Cl. 701/200; 701/211

(57) ABSTRACT

An infotainment system is provided which efficiently manages and provides for the availability of information onboard a vehicle. The infotainment system includes an infogas agent for acquiring information from an external source. The infotainment system further includes a context-based delivery system for delivering context-based information. The context-based information includes a vehicle context advisor for monitoring and storing information relative to vehicle devices and services available on the vehicle. The context advisor further includes a personalization context advisor for monitoring and storing personalization information made available to devices and services onboard the vehicle. The context advisor further includes an environmental context advisor for monitoring and storing environmental information made available to devices and services onboard the vehicle.

### CROSS-REFERENCE TO RELATED APPLICATION

This application claims the benefit of U.S. Provisional Application No. 60/425,526, filed Nov. 12, 2002, the entire disclosure of which is hereby incorporated herein by reference.

### BACKGROUND OF THE INVENTION

The present invention generally relates to systems and services for providing information on a vehicle and, more particularly, to integrated electronics systems that provide enhanced vehicle information services onboard a vehicle.

Current and future automotive vehicles are being equipped with increasing numbers of electronic controllers and related devices. Conventional vehicles generally employ multiple sensors and control modules that may communicate a very limited and defined set of data via a proprietary communication protocol on a dedicated vehicle data communication bus. For example, the vehicle original equipment manufacturer (OEM) data communication bus is generally coupled to an engine control module, a chassis control module, a power train control module, a body module, onboard diagnostics, a speedometer, a fuel level sensor (gauge), and various other electronic devices.

These many vehicles may also be equipped with various infotainment devices such as an audio radio tuner, a compact disc (CD) or digital versatile disc (DVD) player, a navigation system, and one or more human machine interfaces (HMIs), such as a visual display with user input keypads or a voice-based human machine interface employing a microphone and one or more audio speakers. These devices may be individually coupled to a multi-media bus, which is typically separated from the vehicle OEM data communication bus.

Various wireless consumer devices may also be utilized in the vehicle. For example, cellular phones, personal digital assistants (PDAs), and digital music players, such as an MP3, brought into a vehicle may have some limited ability to communicate with one or more vehicle devices via wire or wireless (e.g., Bluetooth) data communication links.

These devices and communication systems collectively provide multiple sources of data and information that can be useful in performing a particular task or objective. For example, it may be desirable for a vehicle navigation system to provide customized navigation services based on vehicle status information, user preferences, and/or weather and traffic information. However, the sources for this diverse data and information are typically implemented within separate and distinct independent systems, thus requiring a very complex dedicated system to be able to gather and process this data for use by a specific system, such as a navigation system.

As future vehicles become even more “intelligent,” the amount of information available regarding the state of devices and systems employed in the vehicle is generally expected to continue to increase. The uses for this information may range from informing the driver that the vehicle needs some specific type of service (e.g., refueling, diagnostic repair, etc.), to enabling dynamic reconfiguration of in-vehicle services and features. To accomplish this with presently available vehicular systems, each device or system interfacing on the vehicle would be required to implement and support numerous separate and unique methods for accessing and processing data from the various sources, both within the vehicle and from off-board.

Further, current infotronics devices and services, which generally include the combination of off-board services, telematics, and personal information and communication devices used to provide advanced in-vehicle information access, generally offer additional information and communication features and services to the vehicle. These infotronics devices and services typically include onboard and off-board navigation capability access to a variety of information and assistance related services, including: traffic conditions reporting, roadside assistance, travel, and concierge services, as well as other types of services. However, vehicles generally do not manage and provide a consistent configuration of such information and, thus, the information is not readily made available to various other devices onboard the vehicle.

Accordingly, it is desirable to provide for a system and method of providing increased availability and access to information onboard a vehicle. It is also desirable to integrate informational services to make a wide variety of information available onboard the vehicle. It is further desirable to provide for a system and method of integrating various types of information made available onboard a vehicle. For example, it is desirable to provide for and make available, vehicle-related information, personalization information and environmental information which may be employed by various devices onboard a vehicle to create a cohesive system which enables new features and enhances the vehicle driving experience.

### SUMMARY OF THE INVENTION

According to one aspect of the present invention, a system and method are provided for providing remote data to a vehicle. The system includes an off-board data source remote from the vehicle. The system also includes a compute platform (e.g., processor) for accessing the data source to acquire information and generating a stream of data as a function of time and location of the vehicle. The system further includes a data communication link for communicating data between the off-board data source and the vehicle. The stream of data is supplied to the vehicle for use onboard the vehicle. Accordingly, updated time and location-based information is readily made available onboard the vehicle.

According to another aspect of the present invention, a system and method are provided for delivering context-based services to a vehicle. The system includes a plurality of context advisors each providing a source of information for a designated category. In one embodiment, the context advisors may include a vehicle context advisor, a personalization context advisor and an environmental context advisor. The system also includes a plurality of service agents. The service agents perform context information filtering based on a requested service. The system further includes an interface for interfacing with an onboard device on a vehicle. The context advisors perform information collection, and the service agents employ the collected information to acquire and store pertinent information. Thus, the efficient delivery of context-based services to a vehicle is realized.

According to yet another aspect of the present invention, a system and method for providing vehicle context information for onboard vehicle devices are provided. The system includes a monitor for monitoring a plurality of onboard vehicle devices and receiving context information. An identifier identifies context information related to each of the plurality of monitored onboard vehicle devices. The system also includes a data storage device having memory for storing vehicle context information for the plurality of onboard vehicle devices. The system further includes an application programming interface for communicating the data storage device with a requesting device onboard the vehicle. The application programming interface downloads the vehicle context information to the requesting device. Thus, the system advantageously makes available information to onboard vehicle devices (including services) from various sources.

According to a further aspect of the present invention, a system and method are provided for providing personalized context information for use with onboard vehicle devices. The system includes an input for accessing and receiving context information, and an identifier for identifying context information related to a person as personal context information. The system also includes a data storage device having memory for storing the identified personal context information. The system also includes an interface for communicating the data storage device with a plurality of onboard vehicle devices. The system further includes an agent for downloading personal context information to one or more vehicle devices. Accordingly, user personal information is made available from a plurality of sources for use on devices (including services) onboard the vehicle.

According to yet a further aspect of the present invention, a system and method for providing environmental context information for use with onboard vehicle devices is provided. The system includes an input for accessing and receiving context information, and an identifier for identifying context information related to the environment as environmental context information. The system also includes a data storage device having memory for storing the identified environmental context information, and an interface for communicating the data storage device with a plurality of onboard vehicle devices. The system further includes an agent for downloading environmental context information to one or more of the vehicle devices. The system advantageously monitors environmental information from various sources and makes the environmental information readily available to devices (including services) onboard the vehicle.

These and other features, advantages and objects of the present invention will be further understood and appreciated by those skilled in the art by reference to the following specification, claims and appended drawings.

### BRIEF DESCRIPTION OF THE DRAWINGS

The present invention will now be described, by way of example, with reference to the accompanying drawings.

FIG. 1 is a perspective view of the cockpit of a vehicle equipped with an infotainment system having user interfacing electronics.

FIG. 2 is a block diagram illustrating a vehicle consumer services interface (VCSI) host platform interfacing with a plurality of electronic host devices in the vehicle.

FIG. 3 is a block diagram illustrating one example of an information transaction using an infogas system according to one aspect of the present invention.

FIG. 4 is a block diagram illustrating a vehicle communicating with off-board context and service providers to acquire information for use in the vehicle.

FIG. 5 is a state diagram illustrating the acquisition of off-board information using an infogas system according to the present invention.

FIG. 6 is a flow diagram illustrating a routine for acquiring information from off-board the vehicle using the infogas system.

FIG. 7 is a graph illustrating blocks of spaciotemporal data that may be acquired and stored in memory for use onboard the vehicle.

FIG. 8 is a block diagram illustrating the functional layout of the VCSI host platform shown in FIG. 2.

FIG. 9 is a block diagram illustrating the advisors and agents implemented in the VCSI host platform.

FIG. 10 is a block/state diagram illustrating various context advisors that may be employed to provide information for use onboard the vehicle.

FIG. 11 is a block diagram illustrating the vehicle context advisor in communication with various vehicle devices.

FIG. 12 is a flow diagram illustrating a routine for placing a phone call using the vehicle context advisor.

FIG. 13 is a block diagram of the personalization context advisor in communication with various vehicle devices.

FIG. 14 is a flowchart illustrating a routine for presenting an activity schedule by employing the personalization context advisor.

FIG. 15 is an example of an input screen displayed to a user for entering user preference information.

FIG. 16 is a block diagram illustrating the environmental context advisor in communication with various vehicle devices.

FIG. 17 is a flow diagram illustrating a routine for providing navigation services using the environmental context advisor.

### DETAILED DESCRIPTION OF THE PREFERRED EMBODIMENTS

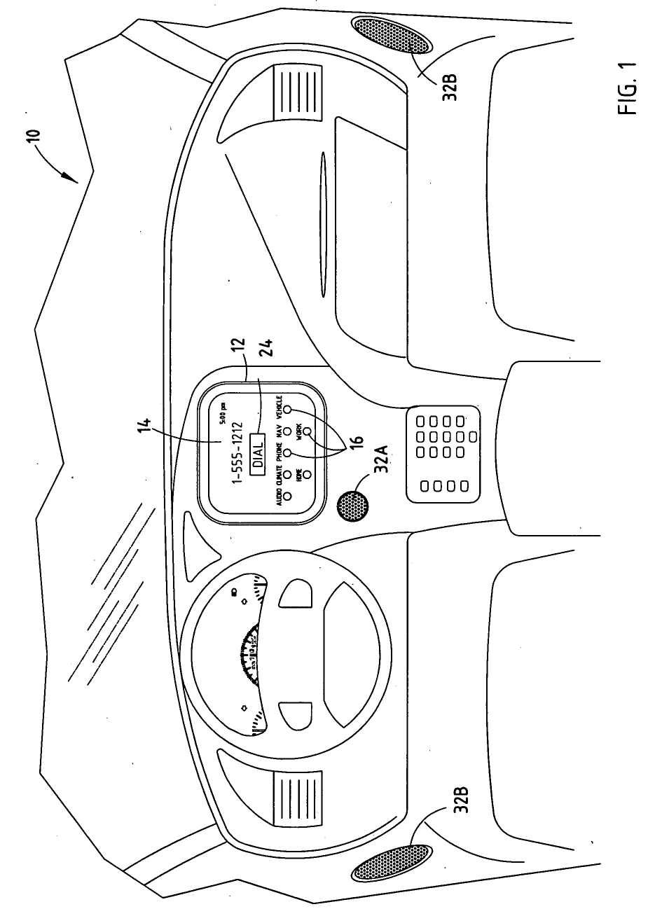

Referring to FIG. 1, the cockpit of a vehicle 10 is generally shown having an electronic system, also referred to herein as an infotainment system, generally located in the vehicle dash. The infotainment system serves to provide any of a number of services generally related to handling information. The infotainment system may provide informational services including entertainment services and telematics services, and thus may serve as an entertainment/telematics system.

The electronic system shown includes a main visual human machine interface (HMI) 12 in the form of a touch-screen display 14 that allows passengers in the vehicle 10 to interface with the electronic system to communicate with one or more electronic devices, including services, that are made available onboard the vehicle 10. The touch-screen display 14 may include a conventional screen for displaying visual images and for providing a plurality of touch-screen inputs, such as the “dial” input button 24 and the following menu inputs 16: audio input, climate input, phone input, navigation input, vehicle input, home input, and work input, as well as a wide variety of other menu selections (not shown). It should be appreciated that various user inputs and outputs may be made available on the HMI 12 for inputting and outputting information used for any of a plurality of electronic host devices to allow a user to interface with the electronic host devices (i.e., machines).

Also shown located within the cockpit of the vehicle 10 is a microphone 32A and audio speakers 32B, which together form a voice-based HMI 12. The microphone 32A is an audio input device that allows for voice speech recognition as a means to provide audio command inputs to the system. The speakers 32B are audio output devices that may include. audio entertainment speakers commonly employed for audio devices in the vehicle 10 and/or may include an audio speaker dedicated to providing voice command outputs to passengers in the vehicle 10. It should be appreciated that the electronic system, including the HMIs 12 and 32, may be located at various locations within the vehicle 10. In addition, the vehicle 10 may be equipped with other HMIs, such as a visual HMI employed in front of the rear passenger seat to allow occupants in the rear seat of the vehicle to interface with an entertainment system or other electronic device(s).

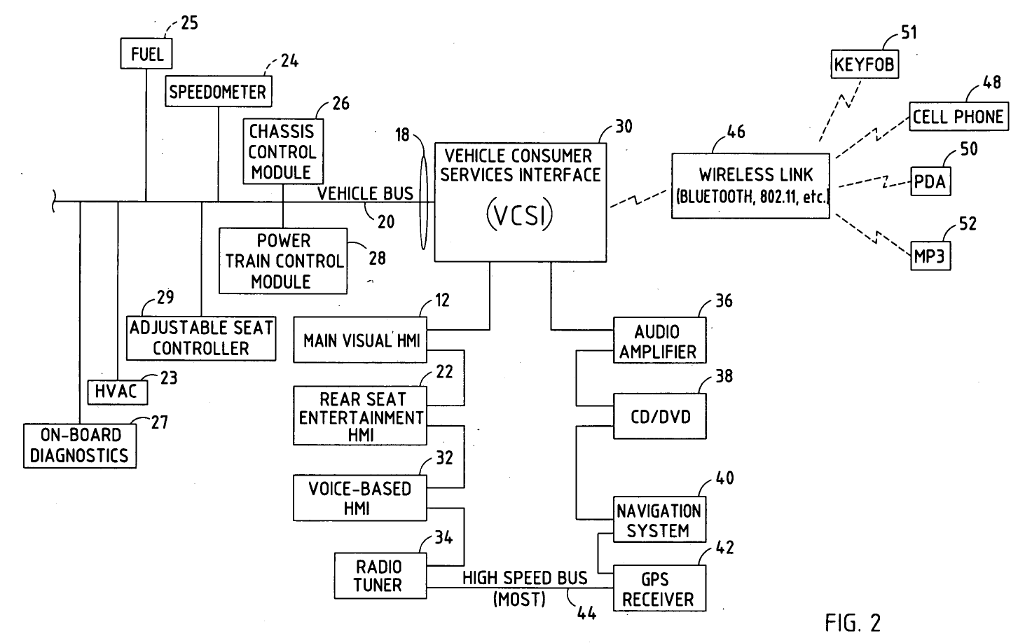

The electronic system also includes a plurality of information and entertainment host devices that are used onboard the vehicle 10. An example of various electronic host devices included with an infotainment system providing entertainment and telematics services onboard the vehicle 10 is illustrated in FIG. 2. The electronic (e.g., infotainment) system includes various electronic host devices coupled to a vehicle consumer services interface (VCSI) host platform 30. The VCSI host platform 30 interfaces with the various electronic host devices within the vehicle 10. VCSI host platform 30 is shown coupled to the vehicle data bus 20, a high speed media oriented system transport (MOST) bus 44, and one or more wireless links 46. The vehicle bus 20 may include a conventional original equipment manufacturer (OEM) bus, such as a CAN or J1850 bus, utilizing a proprietary or non-proprietary protocol dedicated to communicating information among vehicle dedicated control devices including the chassis control module 26 and powertrain control module 28. The vehicle data bus 20 is also coupled to various other vehicle devices and sensors including a vehicle speedometer 24, a fuel level sensor 25, onboard diagnostics 27, heating, ventilation and air conditioning (HVAC) controls 27, and adjustable seat controls 29, as well as various other vehicle devices and services (not shown) as should be evident to those in the art. The vehicle bus 20 is coupled to the VCSI host platform 30 via a firewall 18 which serves to shield mission critical functions of the vehicle 10 from potentially harmful communications.

The VCSI host platform 30 allows various electronic host devices in the vehicle 10 to interface with each other, to interface with off-board devices, and to interface with the HMIs. The VCSI host platform 30 serves as the interface between consumers, networks (both internal and external networks), devices (either factory installed or purchased by consumers “off the shelf”), and the vehicle 10. The VCSI host platform 30 serves as a bridge between different protocols to provide a standardized interface that makes the task of creating in-vehicle applications easy, and further serves to synchronize non-automotive technology devices to that of the vehicle 10. The applications provide services that are implemented through intelligent devices that reside on one or more of the networks. The VCSI host platform 30 may implement network protocols already designed into the vehicle 10, and may enable communication between devices (including services) residing on different networks. The VCSI host platform 30 may also implement application programming interfaces (APIs), thus enabling compatibility and communication between devices (services) provided by a variety of different suppliers. It should be appreciated that the VCSI host platform 30 further includes a communication manager that handles the sending and receiving of messages that are communicated through the VCSI host platform 30.

The VCSI host platform 30 includes a compute platform and memory for storing and executing a plurality of software routines. The memory in the VCSI host platform 30 includes both volatile and non-volatile memory such as random access memory (RAM), read-only memory (ROM), electronically erasable programmable read-only memory (EEPROM), and flash memory. The compute platform includes a processor, such as a microprocessor, for executing the various routines. The VCSI host platform 30 stores and executes HMI applications, service agents, context advisors, and various other applications to perform program services as described herein. The VCSI host platform 30 also manages the storage of information regarding each of these services. It should be appreciated that the software routines implemented in the VCSI host platform 30 and elsewhere in the infotainment system may employ object-oriented programming. An example of an object-oriented programming language may include JAVA, which is a commercially available software package. It should be appreciated that other programming languages may be employed.

The high speed MOST bus 44 is implemented as a wire bus connected in communication with a plurality of electronic devices including the main visual HMI 12. Other HMI devices, including the rear seat entertainment HMI 22 and the voice-based HMI 32, are also connected to the high speed bus 44. Electronic host devices shown connected to MOST bus 44 include a radio tuner 34, an audio amplifier 36, a compact disc/digital versatile disc (CD/DVD) player 38, a navigation system 40, and a global positioning system (GPS) receiver 42. The high speed MOST bus 44 allows data communication between each of the electronic host devices coupled to the bus 44 and the VCSI host platform 30. It should be appreciated that the HMIs 12, 22, and 32, may be otherwise coupled in communication with the VCSI host platform 30 to provide data communication between a user and the VCSI host platform 30 or between the user and any of the electronic host devices. While the VCSI 30 is referred to herein as a host platform, it should be understood that any of the host devices (e.g., radio tuner 34, CD/DVD player 38, navigation system 40) may be configured to operate as a host platform to execute applications and communicate data. It should also be appreciated that other devices having interface capability may serve to function as HMIs.

The VCSI host platform 30 is further able to communicate with various wireless devices including a cell phone 48, a personal digital assistant (PDA) 50, and a media player (e.g., MP3 player) 52, via a wireless link 46. The PDA 50 may include any of a number of digital electronic devices generally including processing capability and memory for storing data information. For example, the personal digital assistant may include a personal computing device (e.g., notebook) having a processor and Internet access. According to another example, another PDA 50 may include a key fob 51 having memory for storing information that may then be communicated to the vehicle 10 and for receiving and storing information from the vehicle 10. It should be appreciated that various other PDAs 50 may be utilized onboard the vehicle 10, as well as off-board. The user of any of the cell phone 48, the PDA 50, the MP3 player 52, and the key fob 51 may travel in and out of the vehicle 10 and communicate with the vehicle 10 via the wireless link 46. The wireless link 46 may include any of a number of wireless communication links including, but not limited to, Bluetooth and 802.11b. Bluetooth provides for wireless data communication generally limited to a short range (e.g., 10 meters), while 802.11b provides enhanced range (e.g., 300 meters) wireless data communication. It should be appreciated that other wire and wireless links, including long range (beyond 300 meters) wireless links, may be employed to provide data communication between electronic devices in and/or near the vehicle 10 and one or more wireless communication devices. It should also be appreciated that a user may interface with any of the wireless devices (e.g., cell phone) via any of the HMIs 12, 22, and 32 communicating via the VCSI host platform 30. Additionally, any of the wireless devices may also operate as a host platform to execute applications and communicate data.

The electronic system referred to herein as the vehicle infotainment system may serve as any of a number of systems including an entertainment system and a telematics system to offer context-based information both onboard the vehicle 10 and off-board the vehicle 10. The electronic system includes an “infogas” system for providing space and time-related (spaciotemporal) information onboard the vehicle 10. The electronic system also includes a system for delivering context-based service with variable time and event based granularity. The electronic system further includes context advisors that monitor the presence and availability of information both onboard and off-board the vehicle 10. The context advisors are implemented as services that focus on information content related to personal preferences and behaviors, the environment, and the vehicle itself. The context advisors include a vehicle context advisor that monitors the status of available vehicle information, both transient and historical, and makes the vehicle context information readily available for use by other devices based on the type of information desired. Also included is a personalization context advisor that provides personalized context information for use with onboard vehicle devices. The personalized context information generally includes information that is personal to a particular individual including personal preferences, schedules, etc. Further, an environmental context advisor is further provided for providing environmental context information for use with onboard vehicle devices. The environmental context information includes information about the surrounding environment including weather, traffic, and other environmental information. It should be appreciated that by providing vehicle context information, personalized context information, and environmental context information, a wide array of integrated information is monitored based on context and made available for use by various electronic devices (including services) both onboard the vehicle and off-board the vehicle to enable a more intelligent and personalized driving experience.

Infogas System

The electronic system includes a system employing an agent, referred to herein as the “infogas” system, for offering services to provide enhanced information (referred to as infogas) to devices, including services, employed onboard the vehicle 10. The infogas system employs off-board data source(s) remote from the vehicle 10. The infogas system includes a compute platform (e.g., processor) for accessing the data source(s) to acquire information and generating a stream of data as a function of time and location of the vehicle 10. The infogas system further includes a data communication link for communicating data between the off-board data sources and the vehicle 10. The stream of data is supplied to the vehicle 10 and made available for use onboard the vehicle. Accordingly, updated time and location-based information is readily made available onboard the vehicle 10.

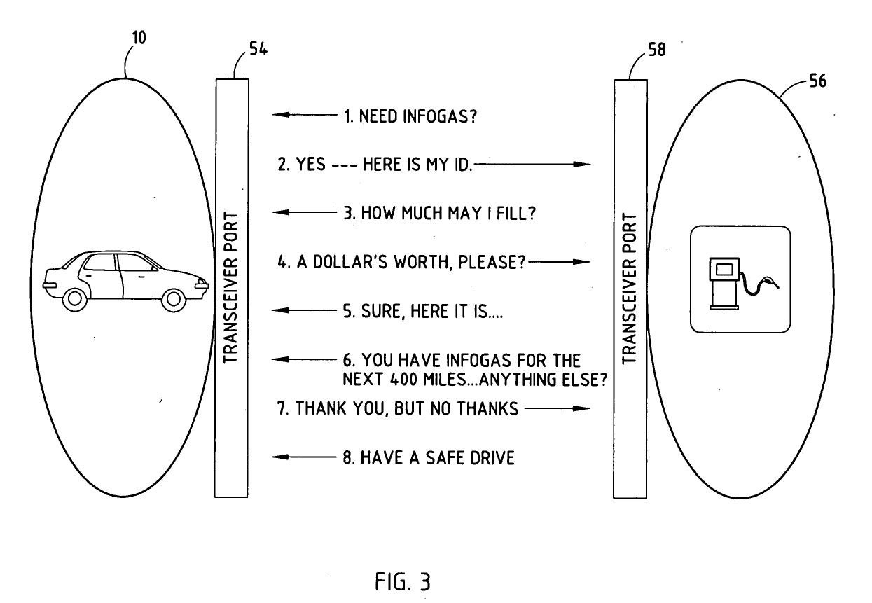

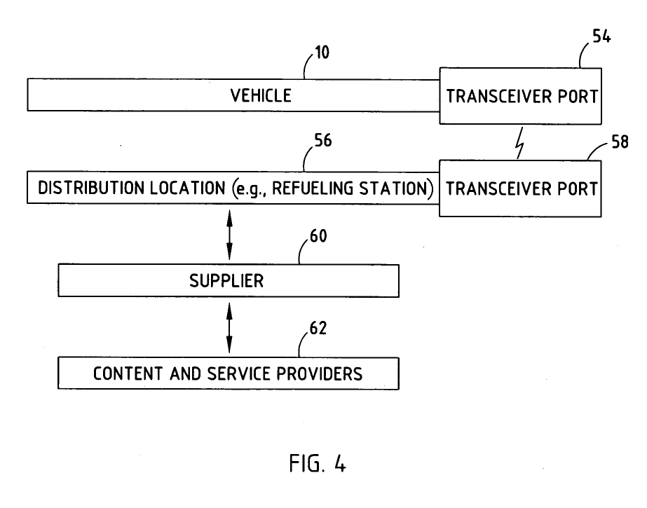

Referring to FIGS. 3 and 4, the vehicle 10 is generally shown having a transceiver port 54 for communicating data between the vehicle 10 and a distribution station, also referred to as location 56. The distribution station is external to the vehicle 10, and, according to one embodiment, is a refueling station. The distribution location 56 is shown also having a transceiver port 58 that is compatible for communicating data with transceiver port 54. The transceiver ports 54 and 58 are configured to transmit and receive data to communicate information back and forth between the vehicle 10 and the distribution location 56.

The vehicle transceiver port 54 and distribution location transceiver port 58 may include any of a number of wire or wireless communication ports for transmitting and receiving data. According to one example, transceiver port 54 may communicate with transceiver port 58 via known short range or midrange wireless links, such as Bluetooth or 802.11b. According to another example, the transceiver ports 54 and 58 may communicate via long range wireless communication. According to a further embodiment, the transceiver ports 54 and 58 may communicate data via a wire or optical fiber connection, both of which offer enhanced data communication bandwidth, but require a physical interconnection.

The distribution location 56 may include any of a variety of locations that provide a local area network (LAN) external to the vehicle 10 for communicating with content and service providers 62. According to one embodiment, the distribution location 56 is a refueling station which also supplies engine fuel (e.g., gas) to the vehicle 10. The distribution location 56, in turn, communicates with a supplier 60 which may access data made available from various content and service providers 62. The supplier may be located at the distribution location 56 or may be remote therefrom. The supplier 60 includes a compute platform, such as a processor, and memory for processing software routines to access data sources, search for requested information, and generate and deliver streams of data containing the information to the vehicle 10. The supplier 60 communicates with the distribution location 56 and content and service providers 62 via wire (e.g., cable) or wireless (e.g., satellite) data connections. Accordingly, the infogas system onboard the vehicle 10 may request information from the distribution location 56, and then the supplier 60 searches for and retrieves the pertinent information from one or more context service providers 62, and delivers the information to the vehicle 10. Thus, the infogas system allows for data exchange between the vehicle 10 and the distribution location 56 as described herein.

According to the embodiment shown, the distribution location 56 is a refueling station that supplies fuel to the vehicle 10 on a somewhat regular basis. Accordingly, when the vehicle 10 requires refueling of engine fuel, the infogas system simultaneously allows for the added downloading of information from the distribution location 56. The infogas system onboard vehicle 10 may automatically establish communication with the distribution location 56 and supplier 60 when the vehicle 10 travels within a predetermined range. According to the example illustrated in FIG. 3, the infogas system of vehicle 10, upon establishing a connection (e.g., wire or wireless) with the transceiver port 58, may undergo a transaction to acquire the infogas information. According to the example shown, the distribution location 56 may initially send a request to the vehicle 10 to ask the vehicle user (e.g., driver) if new data is needed by posing the question “need infogas?” The infogas system in vehicle 10, or the user of the vehicle 10, may respond in the affirmative, and may also supply a secure identification number for security purposes to ensure that the transaction is authorized. The vehicle user may further be asked how much information is wanted, and the infogas system or user may respond based on cost with a quantitative dollar amount. The distribution location 56 then searches the available content and service providers 66 through one or more servicing suppliers 60 to acquire information that may be pertinent to the vehicle 10 and the user (e.g., driver) of the vehicle 10.

The content and service providers 62 may include any of a number of providers of information pertaining to various businesses, road conditions, environmental conditions, personalization information, and various other information databases. The information may be acquired based on information input by the vehicle user such as a future destination, or may be implied based on travel plans or destinations based on monitored driving habits or the direction of travel of the vehicle. The information requested by the vehicle may be requested in advance, or may be entered during the infogas transaction. The supplier 60 and the content and service provider 62 may include subscription services paid for in advance by the vehicle driver or offered at the time of the transaction.

The infogas system minimizes or eliminates the static data obsolescence and low-bandwidth problems of prior approaches by providing a convenient, potentially transparent, connection to the vehicle 10 so as to transmit large amounts of data for a variety of uses by various vehicle devices, including onboard vehicle services. The infogas system also enables multiple onboard vehicle systems to access a common storage device. The infogas system may interact with other systems external to the vehicle 10 and request specific types of data information, based on either implicitly or explicitly implied information from various vehicle systems. The infogas system could also accept unsolicited information from external systems, such as public service information or advertisements.

The infogas system is an adaptation of the refueling mechanism commonly employed for modern day automotive vehicles. The infogas system is connected to an off-board service provider using a substantially transparent means of access which may include wireless or physical connections that are established during the vehicle refueling process, according to one embodiment. The use of wire or optical connections or the use of a short-range wireless communication offers the potential to deliver large amounts of information to the vehicle 10 in a quick and efficient manner. While the refueling station is shown and described herein as the distribution location 56, it should be appreciated that other distribution locations may be employed which include a transceiver port 58 to communicate to supply information to the vehicle 10. The distribution location 56 may include any of a number of wire and wireless data communication stations located at any of various locations. For example, the distribution location 56 may include other locations in close proximity to a roadway on which the vehicle travels to provide a local area network (LAN) that communicates with the vehicle 10. Further, a plurality of distribution locations 56 may be located at various locations along a roadway to provide a series of local area networks, referred to as hot spots, for communicating data with the vehicle 10. Hot spots are known and available in some locations to provide local area network Internet access. If a sufficient arrangement of hot spots are provided, the collective coverage zone of multiple hot spots may provide a continuous area of coverage for communication with the vehicle 10. Other examples of distribution location 56 may include a location at the user's home or work or at other commercial facilities.

While the vehicle 10 communicates with the distribution location 56, the infogas system in vehicle 10 has the ability to request specific types of information, such as a map of the next two hundred (200) miles of highway, points of interest, local activities and events, music and video files, etc. The information acquired may be tagged so as to create a limited usage mechanism in the case of “rental” information. According to one embodiment, time-tagged information may expire at a preset time of day. According to another embodiment, use-tagged information may be used up to a predetermined number of times. Additionally, the off-board supplier 60 may also offer free or recommended information that may be used onboard the vehicle 10. Once the information is acquired, transferred to the vehicle 10 and stored onboard the vehicle 10, the various vehicle devices and services may access the information and a list of the available information and display or otherwise output this information to the occupants of the vehicle 10 for their use.

Once the information is transferred to the vehicle 10, the acquired information may be checked for security purposes and placed in a cache memory, according to one embodiment. When stored in such a cache memory, the acquired information (e.g., data) is then accessible to applications that may choose to reformat the data information and save the data information in application specific areas or in longer-term (persistent) memory storage on or in the vehicle (e.g., on a consumer electronics device such as a PDA).

The infogas system allows for a variable granularity, context-based information telematics and entertainment delivery system that offers wide bandwidth access to data that can be stored onboard the vehicle 10. The infogas system provides data having varying temporal short, medium, long-term value, e.g., traffic, construction, local activities, media entertainment, maps, e-cash, and multimedia entertainment. According to some examples, the infogas system may be used to provide current and local information on road and traffic conditions for travelers, information on current and local activities and attractions, information on restaurants and refueling stations, and other information for various uses. The information delivered by the infogas system can be focused, both to enhance the driving experience and provide opportunity for businesses to advertise directly to individuals that have a known interest in similar products and services. Infogas is consumable information that is spacially and temporally structured to drive the vehicle mobility services with concurrent location and time-based relevance. The infogas content includes a continuum of high resolution through low resolution space and time ingredients. For example, high resolution ingredients may include information about a local neighborhood such as road and freeway conditions and the wait at a local store, all of which is relatively recent in time. Lower resolution ingredients may include known road closures over a two hundred mile span, repair on neighborhood roads over the next week, and future special events (e.g., sports events) that are planned. Accordingly, the resolution of the ingredients for infogas may be structured based on time and location of relevance of the particular information.

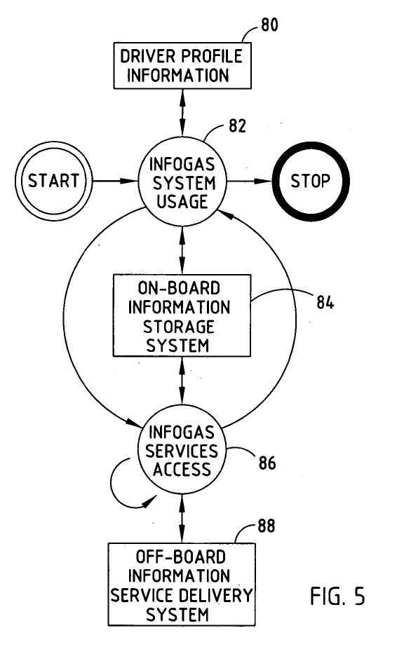

Referring to FIG. 5, operation of the infogas system is further illustrated therein. The infogas system is initiated when the driver enters the vehicle. Once the infogas system is initiated, the usage may begin as shown in block 82 which may initially include identifying the driver of the vehicle 10 and then accessing stored driver profile information in block 80. The driver profile information may be stored in any of several sources including a personal computer located at home, at work, or elsewhere, or another consumer electronics device such as a phone, for example. With the rapid merger of PDA and phone functionalities, it is possible that context-aware driver profiles may be delivered wirelessly directly to the PDA via a combination of several current (e.g., cellular phone), emerging (e.g., Wi-Fi and/or next generation wireless local area networking based on an IEEE 802.11x standard) satellite service to personal devices such as satellite based radio services. Another source for driver profile information could be provided on a smart card or any of a number of personal storage systems, many of which may be easily transportable with the driver and associated with personal transportable items such as a ring, a watch, or a key chain.

The driver profile information may include preferences, interests, and predictor data about the current driver or other users of the vehicle 10. The infogas system can provide requested information to the driver such as points of interests, entertainment, news, etc. The driver may request information stored in the current onboard information storage system 84 or may request information to be acquired during an infogas service access in the future. The driver may access stored infogas resources by directly requesting a specific type or category of information. The infogas system offers access to information that has temporal (time) and/or location relevance. The onboard information storage system 84 contains stored information on the vehicle that has been acquired from devices on the vehicle or has been acquired from the infogas services access 86 during an information transaction. In order to acquire information from off-board the vehicle via the infogas services access 86, the vehicle communicates with the infogas service location. When connected to infogas service access 86, the infogas system can request specific information from the off-board information service delivery system 88 per the driver's instruction, which could include subscription services. The infogas system could also request inferred information per the driver's monitored interests and habits. The infogas system could also provide filtering criteria to allow the off-board service provider to provide additional types of information to infogas service for future access by the driver, either at no cost or for a purchase price. The supplier of the infogas could further issue a digital certificate with discount incentives for a future transaction and notify the driver of the upcoming distribution locations.

When the data communication transaction is complete, the infogas system may acquire additional information via the services access 86 or may return to use the information in block 82. The infogas system will then be able to access the onboard information storage system 84 to utilize the information acquired from the off-board information service delivery system 88. It should be appreciated that the infogas system may be used repeatedly to acquire different types of information from various off-board services. The frequency of repeated access of the off-board sources may depend on availability of distribution locations 56, and the need for additional information, such as new location information or time updated information.

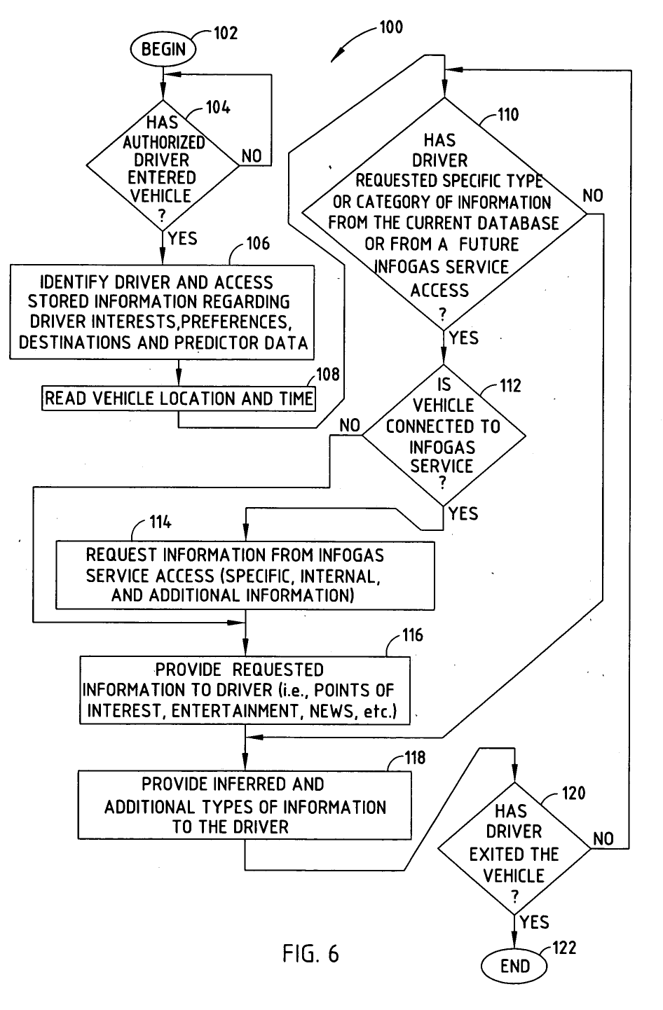

Referring to FIG. 6, a routine 100 is illustrated for acquiring information with the infogas system according to one aspect of the present invention. The infogas acquisition routine 100 begins at step 102 and proceeds to decision step 104 to determine whether an authorized driver has entered the vehicle and, if not, returns back to the beginning. If an authorized driver has entered the vehicle, routine 100 proceeds to step 106 to identify the driver and access stored information regarding driver interests, preferences, destinations, and predictor data. The routine 100 then reads the vehicle location and time of day. The vehicle location may be read as latitude and longitude position coordinates acquired from the GPS receiver. The time of day may also be acquired from the GPS receiver or may be acquired from another clock source. Proceeding to decision step 110, routine 100 determines whether the driver has requested a specific type or category of information from the current database onboard the vehicle or from a future infogas service access to be acquired in the future. If the vehicle driver has not requested a specific type or category of such information, routine 100 jumps forward to step 118. If the driver has requested a specific type or category of information, routine 100 proceeds to decision step 112 to determine whether the vehicle is currently connected to the infogas service access and, if so, requests information from the infogas service access, such as specific, internal, and additional information. In step 116, routine 100 provides the requested information to the driver, such as points of interest, entertainment, news, etc. In step 118, routine 100 further provides any inferred and additional types of information to the driver. In decision step 120, routine 100 decides whether the driver has exited the vehicle and, if so, ends routine 100 at step 122. If the driver has not exited the vehicle, routine 100 returns to decision step 110. Accordingly, the infogas acquisition routine 100 is repeated to allow access to the current database and, upon a request for information from the infogas service access and connection to the infogas service access, additional information may be downloaded from an external source for use by onboard devices and services.

The infogas system advantageously combines time-based information services with spatial location-based services. The type and amount of information supplied to and stored onboard the vehicle 10 by the infogas system depends both on the location of the vehicle and the time of day. Accordingly, routine 100 monitors the vehicle location and the time of day and uses this monitored information to download the appropriate information onto the vehicle 10 so that it is made available for use onboard the vehicle. Thus, the downloaded infogas information provided for a specific task is provided as a function of both the vehicle location and the time of day.

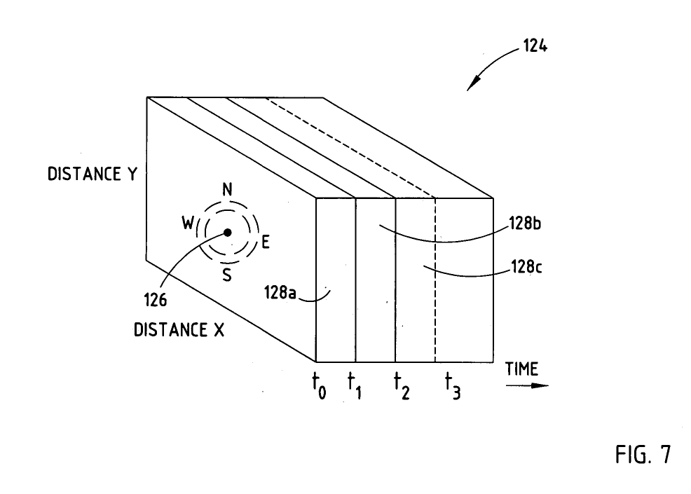

One example of the downloading and storage of infogas information from an external distribution location 56 to memory onboard the vehicle 10 is shown in FIG. 7. The data storage block 124 includes information stored as a function of both time and distance from the vehicle. The distance is shown in both the X and Y coordinates based on two-dimensional travel of the vehicle from location 126. The memory block 124 includes successive blocks of stored information 128A, 128A, 128C, etc. having a time relevance for certain time periods marked by successive time intervals t₀, t₁, t₂, t₃, etc. The information stored in memory block 124 is stored as a function of the distance from the vehicle in both the X and Y coordinates and as a function of time. The type and amount of information that is acquired and stored in data storage block 124 depends on the type of information requested, the location of the user, and the time relevance of the information. Information relevant to a location in close proximity to the vehicle location has a higher resolution and, hence, greater quantity than information relevant to a more remote location. Likewise, information relevant to a more current time is provided at a higher resolution and, hence, greater quantity than information relevant in time far into the future.

The infotainment system stores acquired infogas information in the data storage block 124 for as long as the information may be relevant. When the infogas information expires beyond a predetermined time period, the expired information may be purged from the data storage block 124. For example, when the current time reaches time t₂, information stored in data storage block 128A relevant from time t₀ through time t₁ may be erased from memory, thereby making available space in memory for other information. This is particularly useful when the infotainment system has a limited amount of memory. Thus, the infotainment system efficiently makes use of the available amount of memory. By purging time expired information, the infogas system advantageously minimizes the amount of memory that is required, and thus provides a cost savings. While the infogas information is purged based on an expiration time, it should also be appreciated that the infogas information may be purged based on distance. For example, when the infogas information is relevant to a location which exceeds a predetermined distance, that information may be purged from memory so as to make the limited amount of memory available for other information.

The following scenario helps to further describe the concept of the infogas system. As a driver of the vehicle drives between home and work, on many occasions the vehicle typically follows a quasi-predictable daily route. In this example, when the vehicle is connected to the infogas supplier, information describing the typical route, the driver's interests and hobbies, any potential vehicle maintenance issues, etc., could be uploaded to the supplier to enable the supplier to provide information about future events, businesses, and services adjacent to the anticipated daily routes that are planned or available over the next several days or weeks. The use of the information regarding the anticipated limited geographical range of the vehicle, in this example, enables the supplier to provide greater detailed information relevant over a longer period of time for a specific geographical region. The information acquired may be of potential interest to the driver on more than one occasion and provides multiple opportunities for the driver to take advantage of activities and services in a convenient manner.

Additionally, different types of information can have different levels of interest to the driver at various times during a trip. For example, in the case of the morning commute to work, the driver could experience heightened levels of interest in the weather, road conditions, traffic situations, news and business stories, and certain types of entertainment. The level of interest and timing of information can be used as a means to identify types, and tailor the presentation, of activities and services that the driver would be more in-tune with and more receptive or more appreciative of receiving. This may be achieved in a number of ways. For example, a history of the driver profile could be used to determine the activities and services that the driver would be receptive of receiving. The driver's tastes and preferences could be learned by mining (monitoring) the driver's spending pattern, according to one embodiment.

When traveling beyond a local area, information desired by a driver may change to include the discovery of activities and services in geographic areas less familiar to the driver. In this situation, it is common for the driver to have a smaller, more highly defined set of interests that can be extended over a larger geographical area for a given time period. The infogas system may recognize other situations such as information of interest to someone traveling to a less familiar area having sharper changes in interest levels over shorter periods of time and distance. In this extended travel scenario, information about restaurants, lodging, and special events in the immediate time frame may be of greater interest, than say traffic or weather information. The infogas supplier may therefore provide information about activities and services of interest to a traveler in a timely manner which increases the opportunity for local businesses to offer services that may potentially otherwise be unknown to the traveler.

The time and location based infogas information made available may include multiple overlapping areas of interest which can result in competing priorities. It should be appreciated that the priorities of the driver or other passengers in the vehicle may be manually entered or inferred to further decide what information to provide to the vehicle and its driver or other passengers in the vehicle.

Context-Based Service Delivery System

The context-based service delivery system and method delivers context-based services to the vehicle. The context-based service delivery system has a plurality of context advisors including a vehicle context advisor, a personalization context advisor, and an environmental context advisor, each providing a source of information for a designated category. The context-based service delivery system also includes a plurality of service agents. The service agents perform context information filtering based on a requested service. The context-based service delivery system further includes an interface for interfacing with an onboard device on a vehicle. The context advisors perform information collection, and the service agents employ the collected information to acquire and store pertinent information. Thus, the efficient delivery of context-based services to a vehicle is realized.

In many vehicle applications, there are multiple sources of data and information that may be relevant to a particular task or objective. The context-based service delivery system combines information related to the user's purpose with context-based information, which together may act as an active filtering mechanism for accessing and using data sources in a coherent manner. Thus, the context-based service delivery system provides specific information and related services that are relevant to the individual's current activities, and creates an efficient and appropriate means of communicating this information based on available resources, all achieved in a timely and concise manner.

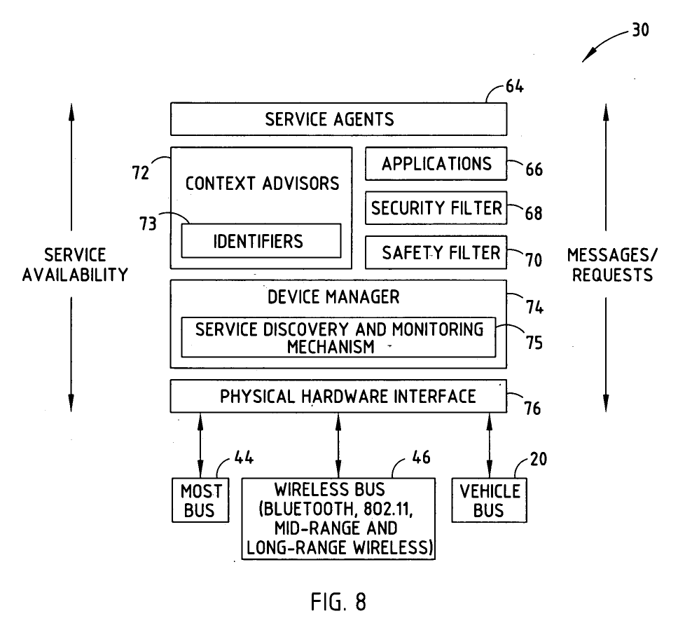

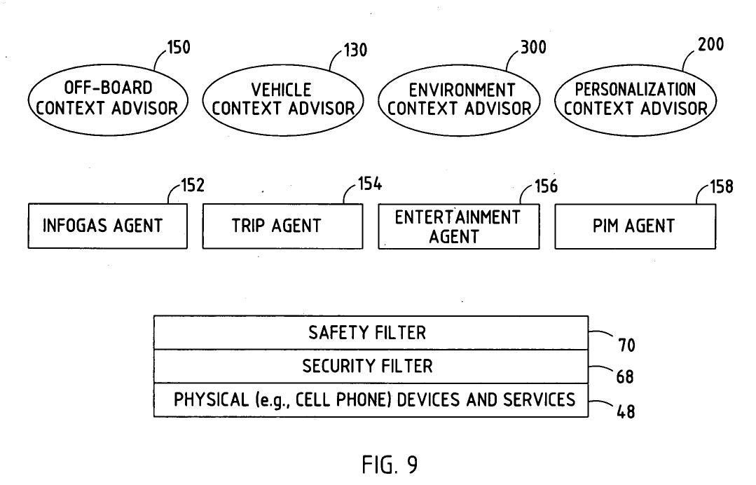

Referring to FIGS. 8 and 9, the context-based services delivery system is generally shown implemented in the VCSI host platform 30. The context-based services system is highly modular and incorporates a plurality of context advisors 72, service agents 64, applications 66, and other software and hardware components. The context-advisors 72 include an off-board context advisor 150, a vehicle context advisor 130, an environmental context advisor 300, and a personalization context advisor 200. The context advisors 72 perform preemptive information collection tasks when the context-based delivery service system is initialized and again when new devices (including services) are activated. The context advisors 72 may include a number of identifiers 73 for identifying context information related to the corresponding context advisor. The off-board context advisor 150 provides information that is relevant to devices (including services) outside (off-board) of the vehicle. The vehicle context advisor 130 provides onboard information that is relevant to devices available on the vehicle. The environmental context advisor 300 provides environmental information that is relevant to surrounding environmental conditions. The personalization context advisor 200 provides personalized information that is relevant to a particular user.

The context-based service delivery system also includes service agents 64. The service agents 64 may address various types of context information like travel planning information with a trip agent 154, entertainment information with an entertainment agent 156, personalization information in a personal information management (PIM) agent 158, and acquisition of off-board information in an infogas agent 152. The service agents 64 generally perform context-based information filtering based on the service or application that is requested.

The context advisors 72 provide information to the service agents 64, or other applications, which, in turn, deliver information and services to the user through physical devices that are connected to any of the high speed MOST bus 44, wireless bus 46, and vehicle bus 20. The VCSI host platform 30 provides a device manager 74 and a physical hardware interface 76 to manage and interface with the various physical devices. The device manager 74 includes a service discovery and monitoring mechanism 75. The service discovery and monitoring mechanism 75 may include a device/service discovery mechanism (application) that detects/monitors the presence and status of each device/component that is made available. By monitoring this information, the identifiers 73 are able to provide certain information about the device and the information that the corresponding device provides. Provided between the applications 66 and the user are layers that filter or broker information and services based on rules for safety and security, and are labeled security filter 68 and safety filter 70. The security filter 68 provides a level of security and may monitor for a properly identifiable user. The safety filter 70 provides a level of safety to minimize risks to the vehicle and its occupants.

The context-based delivery system may be used as a teleprompting system for providing context information by a consumer to off-board services. According to one example, the driver may build a context advisor for a desired scenario describing a desired assistance and outcome. Information may be digitally transmitted and the computing platform in the VCSI host platform 30 may digitally generate context-based response options using digital scenario information and known driver preferences and profiles for off-board service agents to review prior to discussing with the driver. Additionally, the off-board service agent may discuss options with the driver, and, having knowledge of options and driver preferences, may assist the driver with making a final decision.

The context-based services system advantageously reduces the level of detail that a user and/or device, including a service, must manage in order to accomplish a desired objective. The context-based service system also creates an effective context for off-board service providers to dialog with the driver of the vehicle, and provides a common context between the off-board service provider and the driver. Further, the context-based service delivery system enables the integration of onboard semi-static data with off-board dynamic content.

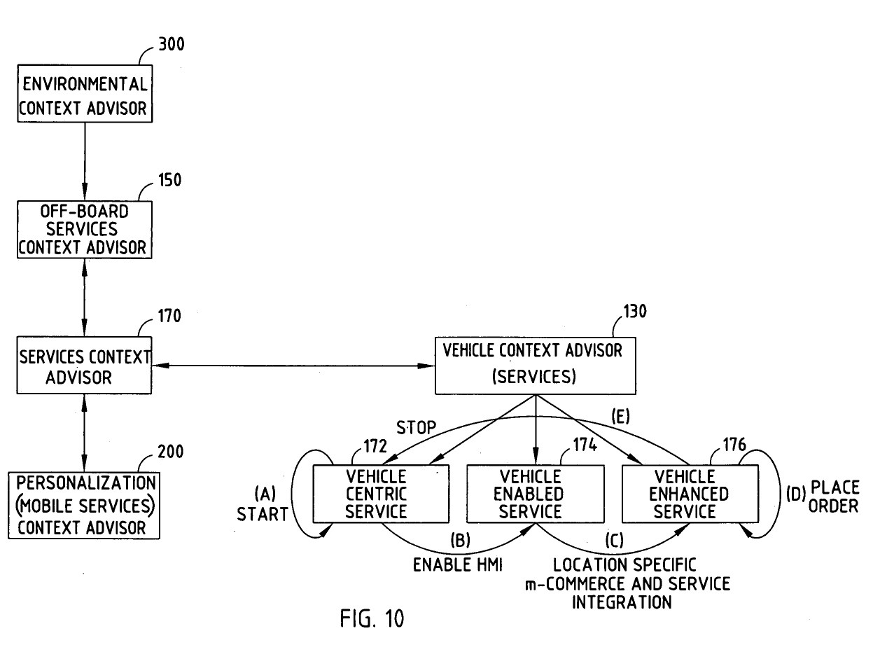

Referring to FIG. 10, an example of data communications during a transaction is illustrated in which a user places an order for goods, such as food. In the example, the context advisors are represented by environmental context advisor 300, off-board services context advisor 150, personalization (e.g., mobile services) context advisor 200, and vehicle context advisor 130. In addition, a services context advisor 170 is further illustrated. The services context advisor 170 provides information pertaining to various services. The vehicle context advisor 130 shown provides those services with functionality shown in blocks 172, 174, and 176. The functionality of vehicle context advisor 130 includes a vehicle concentric service 172 which enables the functions and features incorporated into the vehicle by the original equipment manufacturer (OEM). Examples of vehicle concentric service 172 include climate control, radio, CD player, and personalized settings for devices like seats and mirrors. The vehicle enabled service 174 is enabled by devices and systems that are part of the vehicle when it is delivered to the consumer. An example of the vehicle enabled service 174 is a cell phone that receives power from the vehicle, and possibly uses the audio speakers of the vehicle. The vehicle enhanced service 176 is not only enabled by the vehicle systems, but is more functional, more intelligent, and/or more pleasurable to use in the vehicle environment. The vehicle enhanced service 176 provides functionality primarily where the product differentiation takes place and where the greatest opportunity for a competitive advantage exists.

According to this example, a consumer may be hungry and may want to decide where to dine to eat. According to this arrangement, the vehicle context advisor undergoes a process that encompasses the three levels of services, and is initiated by an input selection made through the vehicle's touch screen display or a voice input of the voice recognition system. Information about the user's preferences is gathered through the personalization context advisor services of the vehicle and from various entries in the user's PDA. The system may further connect to an off-board service provider where location specific information is obtained. Options may be displayed on the in-vehicle display or may be audibly broadcast, and the user may make a selection of both the restaurant and possibly even the specific food order the user desires. Along with information about the restaurant offerings, the system may provide navigation information including route, traffic data, and estimated time of arrival, and other navigation related information to navigate to the restaurant, and may initiate a phone call to the restaurant.

The placing of an order may include starting at step A, enabling the HMI at step B, performing location specific m-commerce and service integration in step C, and placing the order in step D, before stopping in step E. It should be appreciated that the environmental context advisor may provide useful information including weather, city, information, road information, traffic information, regulatory information, location-based information, and commerce information, as well as other information that may affect the information provided to the vehicle user. Throughout this process, the individual context advisors may continue to gather information necessary to provide a high level of service, and each context advisor may contribute any portion of the information that is ultimately employed.

Vehicle Context Advisor

The vehicle context advisor provides for a system that monitors and gathers the status of available vehicle-related information, both transient and historical, and makes the vehicle information available for use by onboard devices based on the type of information desired. The vehicle context advisor system employs a monitor, such as service discovery and monitoring mechanism 75, for monitoring a plurality of onboard vehicle devices and receiving context information. An identifier identifies context information related to each of the plurality of monitored onboard vehicle devices. The system also includes a data storage device having memory for storing vehicle context information for the plurality of onboard vehicle devices. The system further includes an application programming interface for communicating the data storage device with a requesting device onboard the vehicle. The application programming interface downloads the vehicle context information to the requesting device. Thus, the vehicle context advisor system advantageously makes available information to onboard vehicle devices (including services) from various sources.

The vehicle context advisor monitors the presence and functionality of various devices and services available onboard the vehicle. The vehicle context advisor may be implemented in software in the VCSI host platform 30 which interfaces with various vehicle devices by way of wire and wireless communication buses such as the high speed MOST bus 44, the vehicle bus 20, and the wireless links 46. The vehicle context advisor gathers information from the various vehicle devices, including services, that are available onboard the vehicle and either stores in memory the information or stores in memory pointers that address or link to the source of the information. The pointers point to where the information can be read such that applications or agents running onboard the vehicle may acquire this information. The vehicle context information that is static and does not change frequently can be stored in memory. However, when the vehicle context information is dynamic and may change frequently, it may be more advantageous to store pointers in memory that link or point to the source of the information. Thus, up-to-date real-time dynamic vehicle context information is made available.

Applications or agents operating in the vehicle may use the vehicle context advisor to determine which devices are available onboard the vehicle in order to deliver various types of services and functions to the driver and/or passengers of the vehicle. These devices may include sensors and various other devices installed by the vehicle manufacturer, as well as devices introduced into the vehicle by the occupants of the vehicle including cell phones, PDAs, MP3 players, and other devices. Additionally, the HMI devices are also monitored by the vehicle context advisor so that information about the HMIs is readily available.

The vehicle context advisor gathers the information about available onboard vehicle devices, including services, and stores this information in a memory look up table, according to one embodiment. The look up table may provide information concerning the status of a particular device, the services or information that each particular device offers, and how each device can be accessed. In lieu of storing the information about each device in the look up table, a pointer that points to an address of each particular device may be stored in a look up table such that another software application executed by a device may be pointed to the particular device of concern to acquire information regarding status, services and information available, and how to access such devices. This is particularly advantageous for use with dynamic information.

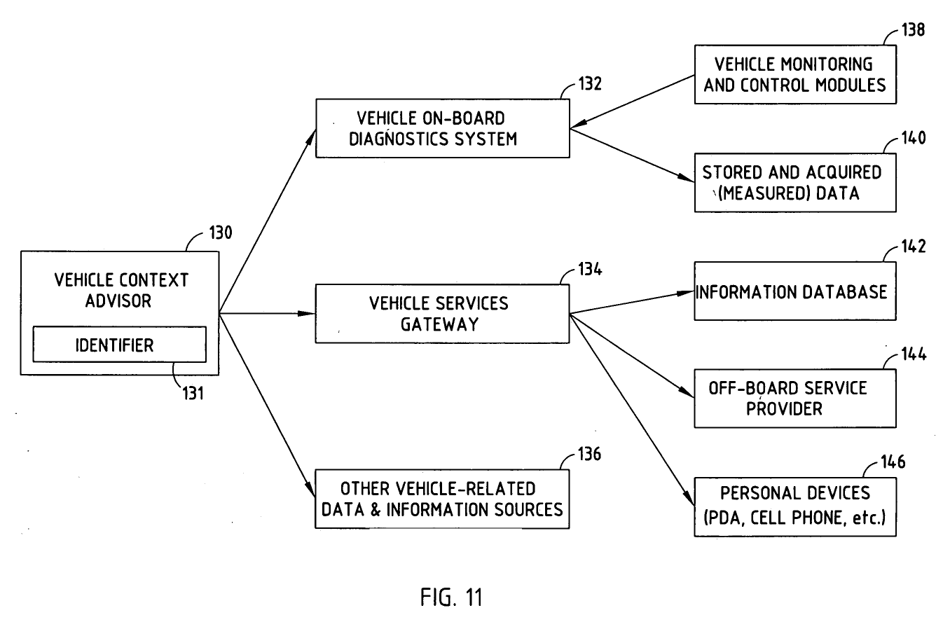

Referring to FIG. 11, the vehicle context advisor 130 is shown monitoring data that is made available to other applications, according to one example. The vehicle context advisor 130 includes an identifier 131 for identifying context information related to each of the plurality of monitored onboard vehicle devices. The identifier 131 provides information about the various devices and the information that such devices provide. The identifier 131 may acquire the vehicle context information by using the service discovery and monitoring mechanism 75 of the device manager 74. The vehicle context advisor 130 communicates with the vehicle onboard diagnostics system 132 to acquire diagnostics monitored data. The onboard diagnostic system 132 routinely receives data from vehicle monitoring and control modules 138 from stored and acquired (measured) data stored in a memory block 140. By monitoring the vehicle onboard diagnostics systems 132, the vehicle context advisor 130 is able to monitor information about various vehicle devices including, for example, tire pressure and temperature, engine temperature, current and historic gas mileage, maintenance history, vehicle speed, fuel level, and service needs of the vehicle. The stored and acquired data 140 may include data that is otherwise stored by a passenger in the vehicle.

The vehicle context advisor 130 also monitors information database 142, off-board service provider 144, and personal devices 146 by way of the vehicle services gateway 134. By monitoring the personal devices, the status of various personal devices brought into the vehicle, including the cell phone, PDA, MP3 player, can be monitored by the vehicle context advisor 130 to determine what devices, including services, are in the vehicle and available for communication, and how to access these devices (services). The off-board service provider 144 further provides information available from off-board devices (services) which may further allow for monitoring devices that may not currently be located onboard the vehicle. The information database 142 may include any other databases that are in communication with the vehicle services gateway 134 that include vehicle context information.

The vehicle context advisor 130 further monitors other vehicle-related data and information sources 136. These other vehicle-related data and information sources may include any of a number of sources that are made available onboard the vehicle and contain information regarding onboard vehicle devices (services).

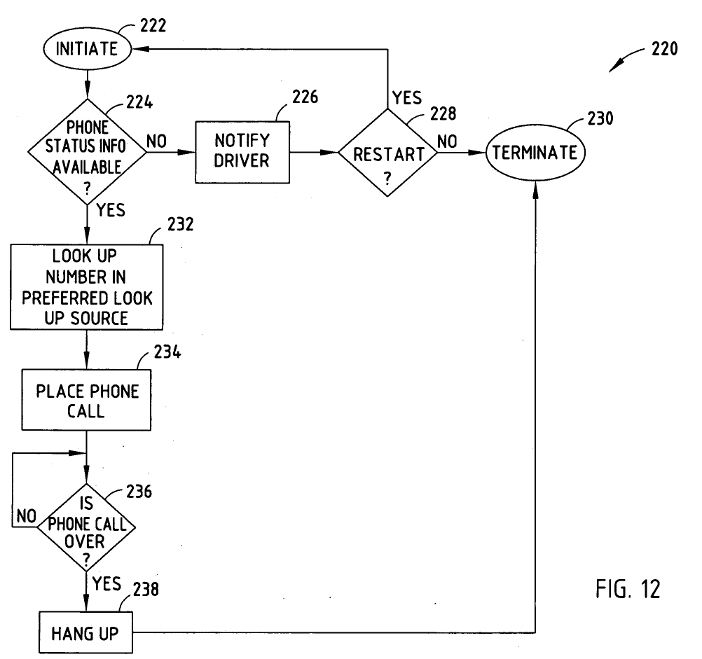

By monitoring the status of devices (services) available onboard the vehicle, the vehicle context advisor 130 is able to efficiently enhance various applications that utilize information or services offered by these onboard devices (services). Referring to FIG. 12, an example of an application that uses vehicle context information to place a phone call is illustrated therein. The application shown is a routine 220 for placing a telephone call which begins at step 222, and proceeds to decision step 224 to check whether the cell phone status information is available. If the cell phone status information is not available, the driver is notified in step 226. Following notification of the driver, the telephone call routine 220 determines whether the vehicle has been restarted and, if not, terminates the routine 220 in step 230. If the vehicle has been restarted, the routine 220 returns to the initial step 222.

If the phone status information is available in decision step 224, telephone call routine 220 proceeds to look up the phone number in a preferred look up source in step 232. The preferred look up source may include a look-up table in memory containing a plurality of phone numbers which are efficiently made available by the personalization context advisor as described herein. Thereafter, the telephone call is placed in step 234. In decision step 236, routine 220 decides if the phone call is completed and, if so, hangs up before terminating in step 230. Accordingly, the telephone call initiation routine 220 is achieved by advantageously employing the stored telephone status information which is monitored and made available by the vehicle context advisor.

It should be appreciated that the vehicle context advisor monitors the status of available information about various other devices on the vehicle and allows for the various devices to communicate and employ information about other devices. It should also be appreciated that the vehicle context advisor routinely monitors and, thus, already knows the status of the phone that places the call, the presence of a voice recognition system, the status of the vehicle's microphone and sound system, and the onboard sources of contact information. Additionally, the off-board service advisor is also aware of any off-board source of contact information and call placement service availability.

If a telephone call is initiated by a voice recognition system, the user may speak (input) into the voice recognition system “call John Smith.” Through the vehicle context advisor, the application knows that the phone service is available and that it can look in a PDA or other device for the phone number for John Smith. Likewise, the application learns from the vehicle context advisor that the vehicle microphone and sound system may be used to facilitate the call. Another example may include a navigation agent to provide a comprehensive navigation service that can be delivered to customers. The navigation agent can gather data from various sources and deliver the data to the user in a variety of formats by employing the vehicle context advisor, the environmental context advisor, the personalization context advisor and any off-board services. In the navigation example, the navigation agent may require knowledge of GPS location data, availability of stored locally or delivered real time maps, how to access weather data, where to get data on road conditions, and which HMI devices are available to deliver this information. The vehicle context advisor serves as a source of this information for the status of the available onboard devices (service) functions.

Personalization Context Advisor

The personalization context advisor provides a system that monitors and provides personal information for use with onboard vehicle devices. The personalized context advisor system includes an input for accessing and receiving context information, such as via the service discovery and monitoring mechanism 75, and an identifier for identifying context information related to a person as personal context information. The personalized context advisor system also includes a data storage device having memory for storing the identified personal context information. The system also includes an interface for communicating the data storage device with a plurality of onboard vehicle devices. The personalization context advisor system further includes an agent for downloading personal context information to one or more vehicle devices. Accordingly, user personal information is made available from a plurality of sources for use on devices (including services) onboard the vehicle.

The personalization context advisor detects the presence of personal devices and user preference information introduced either directly by vehicle occupants by way of electronic devices such as PDAs or through an off-board service providers. The personalization information may include user preferences related to traditional vehicle memory systems such as seat settings and radio presets. Additionally, the personalization information may be more comprehensive in nature like preferred music genre, personal driving habits, biometrics, and preferred cuisine, amongst various other personal user preferences. The personalization information is monitored and stored so that it may be used by various systems within the vehicle environment. Additionally, the personalizable context advisor provides the vehicle with information about the driver that enhances the functionality of various onboard systems including safety systems such as air bags and seatbelt pretensioners to enhance the operation of these devices.

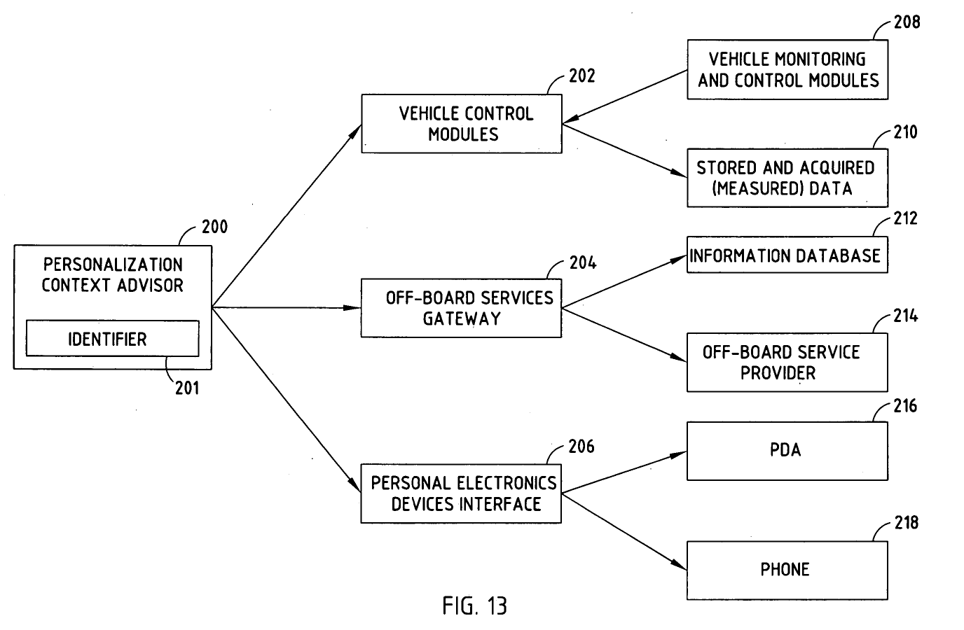

Referring to FIG. 13, the personalization context advisor 200 is shown communicating with the vehicle control modules 202, off-board services gateway 204, and personal electronics devices interface 206, according to one embodiment. The personalization context advisor 200 includes an identifier 201 for identifying context information related to a person. The identifier 201 may acquire the personalized context information by using the service discovery and monitoring mechanism 75 of the device manager 74. The vehicle control modules 202 communicate with vehicle monitoring and control modules 208 to monitor the chassis control module, the adjustable seat controller, the HVAC control settings, onboard safety systems, all of which may have personal settings or may be controlled based on a personal settings. Accordingly, the personalization context advisor 200 monitors and stores the information that is personal to a particular user so that this information may be used by various vehicle systems in an efficient manner. The vehicle control modules 202 may also monitor personal information available in the stored and acquired data memory block 210. It should be appreciated that the personalization context advisor may store the information in a look up table in memory or may provide a pointer that points or links to the information.

The personalization electronics devices interface 206 may interface with any of a number of available personal electronic devices including consumer purchased devices that are brought into the vehicle environment by a passenger, such as the driver. Examples of personal electronic devices include the PDA 216 and cell phone 218, as shown. Other examples of personal electronic devices include personal computing devices, music and video players, and key fobs. It should be appreciated that many personal electronic devices contain a variety of information stored in memory that is personal to the user of the electronic device. For example, the PDA 216 may include information such as business and home addresses, phone numbers, appointment schedules, travel plans, and various other personal information. The cell phone 218 may include telephone contact information including business and home phone numbers. These and other types of personal information may be useful in other devices onboard the vehicle. Accordingly, the personalization context advisor 200 monitors each of these personal electronic devices and stores the pertinent personalization information in memory or stores address pointers in memory that will point or link to the pertinent personalization information so that other devices, including services, onboard the vehicle may utilize the personalization information. The actual information may be stored for static information, while the pointers are useful for efficiently monitoring dynamic information. Thus, a wide variety of personalization information is readily made available onboard the vehicle by way of the personalization context advisor 200.

The off-board services gateway 204 enables the personalization context advisor 200 to communicate with an off-board information database 212 and an off-board service provider 214 when a data communication path is available. By way of the off-board services gateway 204, the personalization context advisor 200 is able to access personalization information stored in the off-board information database 212. The information database 212 may include an external computer at home or at work which may contain scheduling appointments and contact information that was stored by the user in an environment outside of the vehicle. The off-board service provider 214 may search for personalization information from various databases and report the personalization information to the personalization context advisor 200, which then stores the information or pointers in memory. The off-board service provider 214 may include a personal information management (PIM) provider that helps to manage information for an individual including medical and health related information. Thus, the personalization context advisor 200 further aids in delivering a more intelligent set, of services and functions that are more uniquely suited to the vehicle users.

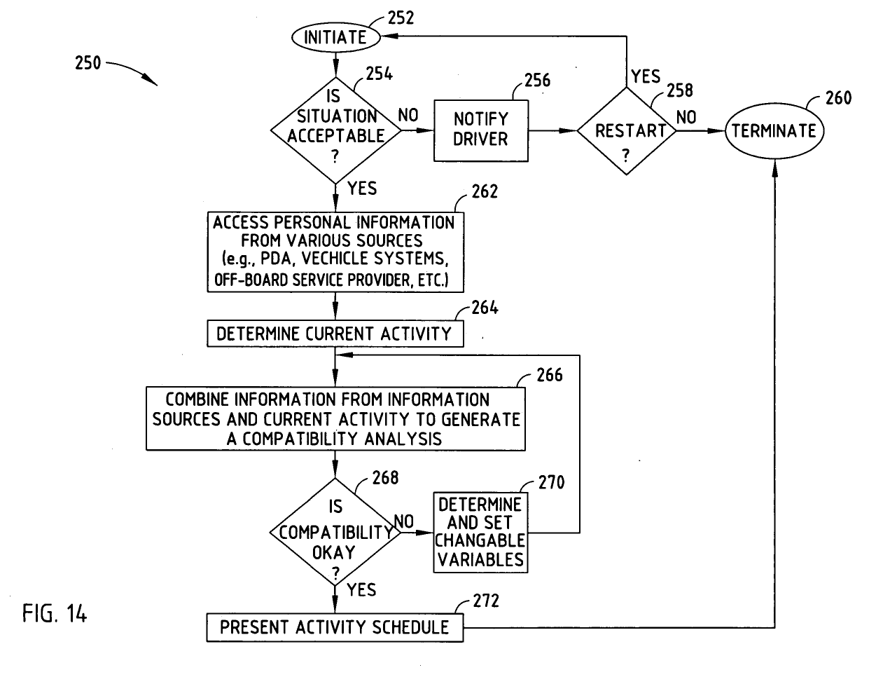

An example of a personalized activity planning routine 250 employing the personalization context advisor 200 for planning an activity schedule is illustrated in FIG. 14. The planning routine 250 is initiated in step 252 and proceeds to decision step 254 to determine whether the current situation is acceptable to generate and present an activity schedule. If the current situation is not acceptable, planning routine 250 notifies the driver of the unacceptable situation in step 256, and then checks for whether the vehicle is restarted in step 258. If the vehicle is restarted, the planning routine 250 returns to the beginning at step 252. Absent a vehicle restart, the planning routine 250 is terminated in step 260.

If the current situation is determined to be acceptable in decision step 254, the personalized activity planning routine 250 proceeds to step 262 to access personal information from various personalized virtual information sources including any of available PDAs, vehicle systems, off-board service providers and other available sources. The personal information is accessed and readily made available by the personalization context advisor. Next, in step 264, the planning routine 250 determines a current upcoming activity that can be presented in the activity schedule. One example of a current activity may include refueling the vehicle with infogas information and/or engine fuel. In this example, the planning routine 250 will evaluate the driver's planned route and will schedule a refueling stop based on the need for refueling and the availability of refueling stations along the route. In step 266, the information from the personalized virtual information sources and the current activity are combined to generate a compatibility analysis. In decision step 268, planning routine 250 determines if the compatibility is okay and, if so, presents an updated activity schedule in step 272 before terminating in step 260. If the compatibility is not okay, planning routine 250 determines and sets changeable variables in step 270 and then returns to step 266 to combine the personalized information with the current activity to generate a new compatibility analysis, until the compatibility is okay.

By providing the personalization context advisor, various activity planning routines may benefit from the personalization information that is efficiently managed and made available throughout the vehicle. Accordingly, various other applications and agents may easily employ the personalization information provided by the personalization context advisor of the present invention. It should be appreciated that driver preferences may be determined or inferred (e.g., learned) based on various activities, weather, clothing, and other driver profile characteristics. It should also be appreciated that a personalized profile pattern template may be generated by observing driver actions and inferring certain user preferences. The personalized activity planning routine 250 may collect information pertaining to an upcoming activity, combine the upcoming activity information with the driver profile information and stated preferences, and generate a schedule with sequential activities to accomplish the mission planning activity.

Additionally, individuals are also provided with greater opportunity to adjust and control their surroundings in vehicles, at home, and at work, to allow individuals to set temperature, lighting, entertainment, and information preferences for different areas according to the individual's preferences. Many vehicles allow users to create a preferred settings profile, commonly referred to as the “memory” feature, which enables a user to store user preferences for adjustable vehicle settings. The adjustable vehicle settings may include adjustment of radio stations, suspension settings, power train settings, and seat, pedal, and mirror positions. Typical vehicle arrangements for adjusting user preferences are generally limited to a small number of individual settings which often requires that the driver manually create the same adjustments in each vehicle. Such an arrangement does not fully accommodate shared access of a vehicle by several drivers or the situation where a driver drives multiple vehicles.

Various user preferences that are personal to a particular user may be entered by the user into a memory storage device via a data entry and/or computing device. For example, a user may enter a list of preferences, such as user preferred types of rental car, hotel, restaurants, preferred routes and roads, preferred carriers, and other reservations. Additionally, user preferences may be inferred based on user activities. User preferences can be inferred based on habits and repetitive usage of a certain rental car business, hotel, routes, and other user selectable activities.

The personalization information can be stored onboard the vehicle in data storage memory. The data storage memory may include memory available in the VCSI host platform 30 or any other memory storage available onboard the vehicle. The personalization information could also be stored on a portable personal data storage device, such as a PDA or a key fob. According to one embodiment, a portable key fob 51 having data storage memory and the ability to communicate with the vehicle may be employed to store personalization information. The key fob 51 may be carried in and out of the vehicle 10 and, when onboard the vehicle, may communicate with the VCSI host platform 30 via the wireless link 46 or may employ another communication connection (e.g., wired). The key fob 51 may store preferred vehicle feature settings including radio station settings, climate control settings, telephone speed dial settings, etc. The vehicle settings may be downloaded to the vehicle so that the vehicle modifies settings onboard the vehicle to set the radio, climate control, telephone speed dial presets, and other selectable settings according to the preferences stored in memory on the key fob 51.

Additionally, the key fob 51 may store current settings in the vehicle so as to enable an audio entertainment system in another environment, such as the home environment, to be programmed to automatically tune to the radio station last listened to in the vehicle when the user arrives home. This seamless transition of information can be extended to lighting, temperature settings, web sites, and other activities. Thus, the use of a portable memory device, such as a key fob 51, allows for the ability to create transparent interaction between the vehicle environment and other environments to transfer user preferences from one environment to the other environment.

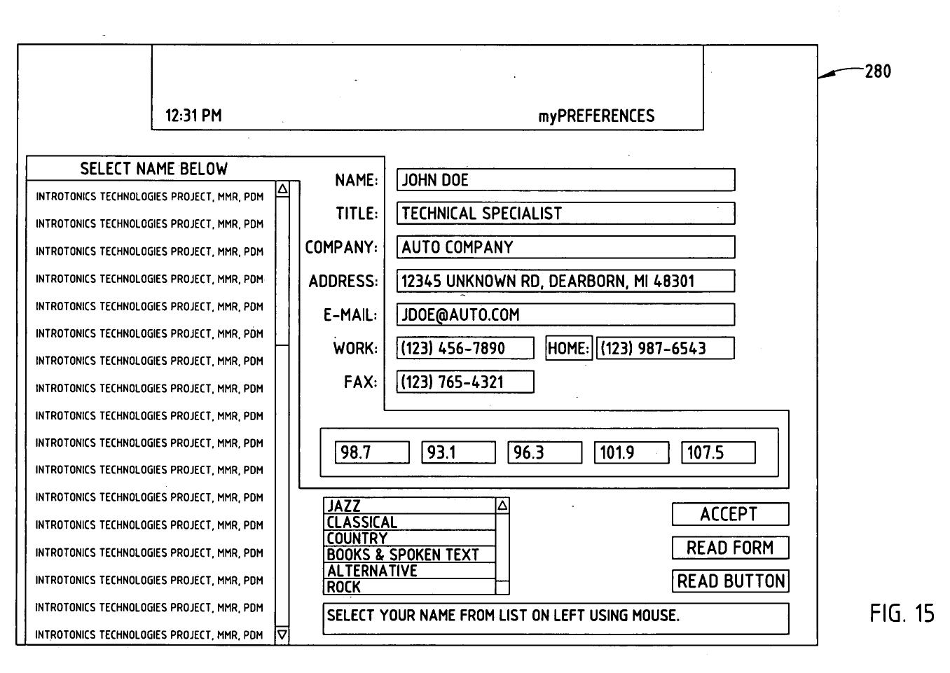

In an initial environment, a user may create a basic preferences profile containing preferred contact information, preferred music, telephone settings, along with e-mail and other contact information, some of which is shown as menu selections in the input display 280 illustrated in FIG. 15. The input display 280 includes a menu for entering personal information which may be entered and stored on a PDA, such as a personal computing device, and then stored on a key fob or other memory storage device. The user preference information may then be transferred between any of a home environment, a work environment, a vehicle environment, a recreational environment, and other environments to allow access and use of the preference information stored on the key fob. In a home environment, a user may select music titles for listening to when in the vehicle via the Internet or other sources. The titles of the selected music may be stored on the key fob 51 in the form of a play list and the music may be wirelessly transmitted to the vehicle when the key fob 51 is carried into the vehicle 10. This process may create a custom, personalized, audio entertainment experience for the user within the vehicle. In a work environment the user can access the home environment, check e-mails, and perform other activities automatically. Further, in a dealership and vehicle maintenance services environment, a vehicle dealer can recall information from the key fob 51 not only about the vehicle but about the individual's ownership experience and history with the vehicle. This may enable the dealer to offer specific vehicle-related services and information that is customized for each particular user.

Accordingly, the personalization context advisor provides a means to monitor personal information and to transfer personal information to any of a number of devices onboard the vehicle. The personalization context advisor enables individuals to electronically store and recall preferences and use these preferences in various areas of the individual's lifestyle by using a portable device, such as a key fob 51, to store personalization information and user preferences in various environments including the vehicle, home, work, recreational environments. The personalization context advisor can be employed in combination with any of the other context advisors including the vehicle context advisor to allow easy access to onboard devices and services to more efficiently utilize user preferences. By employing the portable data storage key fob, the potential to enhance daily transitions among multiple environments becomes increasingly realizable as intelligent electronics are applied to everyday devices in smart homes and appliances, network entertainment systems, Internet connected appliances, wireless phones and PDA, electric locks and access systems, as well as other devices.

The personalization information context advisor creates new opportunities by enabling devices in other environments to access the individual's preferences and intelligently adjust to the activities and interests of the individual. In the above example, an in-home audio entertainment system may automatically tune to the radio station last listened to in the vehicle when the individual arrives home with the key fob to create a seamless audio/information transition between the vehicle and the home environment. This concept can be extended to adjusting lighting levels, temperature settings, web sites, bookmarks, and other personal settings when traveling between work, home, recreation, vehicle, and other environments. According to this example, in the process of arriving home and unlocking the door, the data storage key fob containing the personalization information may update the home with relevant information about recent activities of the individual. Similarly, the situation of leaving the home presents similar opportunities in that the key fob could automatically update stored information regarding recent home activity, associated work, recreation, scheduled activities, etc. This information could reference music genre and sources that the individual has indicated are preferenced to, either through recent listening or long-term trend monitoring, information about recent Internet activity, work-related activities, etc. The preference and pattern monitoring can be extended to include shopping lists, temperature settings, new sources of entertainment, along with information related to financial institutions, preferred access providers for Internet, e-commerce, service providers, etc. The aspect of personal safety can further be extended to include special medical conditions or medical histories.

In the vehicle environment, the personalization context advisor monitors and provides the individual's preferences for various vehicle features and settings that may be set automatically. The data storage key fob 51 may transparently communicate with the vehicle as the driver enters the vehicle to enable the necessary readjustments that would be made automatically. The key fob 51 could initially acquire the vehicle settings either directly from the vehicle, or via some intermediary, such as a desktop personal computer running on a personalization acquisition application. By employing a portable memory storage key fob 51, the personal settings may remain with the user, thus allowing the user to use these preferences in one or more other vehicles and other environments. The level of information that is retained and stored on the key fob 51 could also be extended using an external agent that queries vehicle devices. This could be in the form of either software added to an existing vehicle module or the data storage key fob 51. The agent could interrogate vehicle features not originally designed with the personalization capability and the key fob could then be used to configure these additional features. The key fob 51 could be used to access additional information related to vehicle maintenance, repair tracking, and service scheduling. This information could be collected and analyzed for vehicle prognostics/diagnostics, fuel economy monitoring, and tracking information for work-related and personal vehicle use. This may enable vehicle users and owners to transparently manage this type of information.

By monitoring personalization information, the personalization context advisor may automatically provide information and reminders to the vehicle user about appointments that are stored on a PDA or other device. The personalization context advisor could further automatically initiate the display or announcement of details of the appointment to the driver using tactual or audible responses regarding the disposition of the appointment. The interaction with various devices onboard the vehicle can be extended to where the vehicle combines the functionality of the PDA with other devices such as a cell phone so as to initiate a telephone call using the cell phone, based on appointment or contact information stored in the PDA, and with the vehicle audio system providing the HMI interface. Thus, the vehicle can combine the cell phone and similar wireless links with the PDA using stored preferences to create a means for information from an off-board service provider to be delivered in a timely fashion.

Enviromental Context Advisor

The environmental context advisor provides a system that monitors and provides environmental information for use with onboard vehicle devices, including services. The environmental context advisor system includes an input for accessing and receiving context information via the service discovery and monitoring mechanism 75, and an identifier for identifying context information related to the environment, referred to as environmental context information. The environment context advisor system also includes a data storage device having memory for storing the identified environmental context information, and an interface for communicating the data storage device with a plurality of onboard vehicle devices. The environmental context advisor system further includes an agent for downloading environmental context information to one or more of the vehicle devices and services. The environmental context advisor system advantageously monitors environmental information from various sources and makes the environmental information readily available to devices onboard the vehicle.

The environmental context advisor identifies the availability of information related to the environment, determines how to access the environmental information, and gathers the environmental information from various vehicle controllers and systems that monitor the presence and/or functionality of any environmental condition. The environmental context advisor may be implemented as software stored and executed in the VCSI host platform 30 which communicates with the various vehicle devices via wire or wireless communication including the vehicle bus 20, high speed MOST bus 44, and wireless link 46. In addition to gathering information from onboard vehicle devices of the system, the environmental context advisor also communicates with off-board sources to identify environmental information such as weather, road traffic, and construction information. The environmental information may include any information related to the environment in which the vehicle is operated, including any routes or destinations where the vehicle may travel. The environmental information includes weather conditions and forecasting (e.g., temperature, pressure, wind, rain, snow, fog), traffic and road conditions (e.g., traffic delays, road construction), and other environmental conditions.

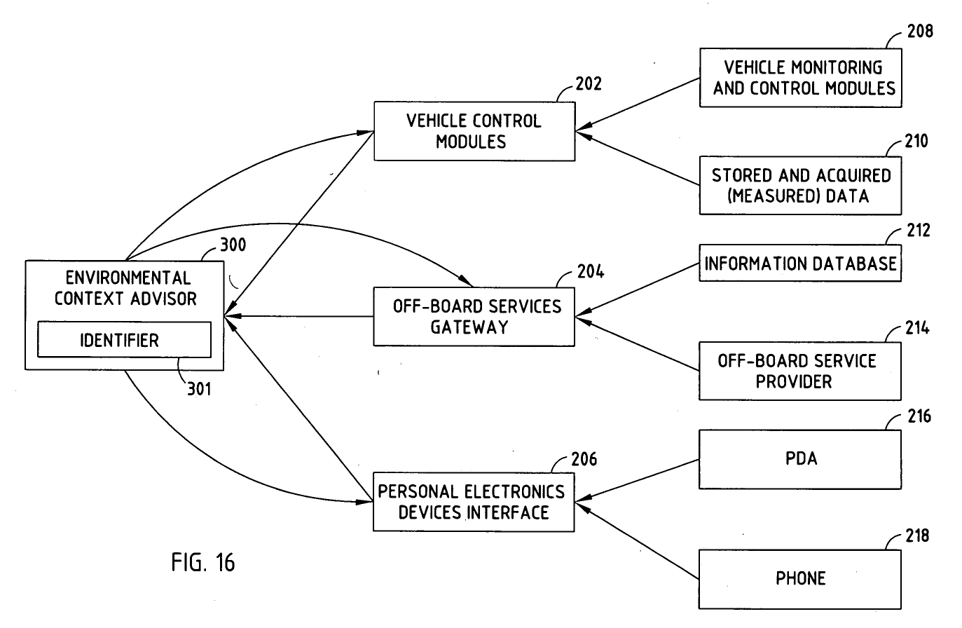

The environmental context advisor 300 is shown in FIG. 16 communicating with vehicle control modules 202, off-board services gateway 204, and personal electronics devices interface 206. The environmental context advisor 300 includes an identifier 301 for identifying context information related to the environment. The identifier 301 may employ the service discovery and monitoring mechanism 75 of the device manager 74 to monitor and identify the environmental context information to be made available for use in the present invention. The vehicle control modules 202 communicate with vehicle monitoring and control modules 208 and stored and acquired (measured) data in memory block 210. By communicating with the vehicle control modules, the environmental context advisor 300 is able to monitor various control systems including the chassis and powertrain control modules which typically include sensors that measure ambient temperature, pressure, wind velocity, and other environmental conditions. The stored and acquired data in memory block 210 may include other acquired environmental information.

The off-board services gateway 204 communicates with an off-board information database 212 and off-board service providers 214. The off-board service providers 214 may include a service that delivers weather conditions that are frequently broadcast via radio and satellite communications channels. Accordingly, the environmental context advisor 300 is able to monitor up-to-date weather conditions and makes this information available to various devices, including services, onboard the vehicle. The information database 212 may provide other information entered by the driver or may determine inferred conditions such as road construction. The information database 212 may also store other environmental information stored or used for other devices (services) outside of the vehicle.

The personal electronics devices interface 206 allows communication with various devices including the PDA 216 and the cell phone 218. The PDA 216 and cell phone 218 may provide personal profile information that includes planned destinations, routes, preferred shortest and fastest travel routes, and other information that may be useful for determining what environmental information to store in memory. Accordingly, the environmental context advisor 300 monitors and stores a wide array of environmental information that may be used by various devices (services) onboard the vehicle for enhancing the vehicle driving experience. It should be appreciated that applications or agents running onboard the vehicle may use the environmental context advisor to determine what information is available as the applications or agents deliver the various types of services and functions to the driver and/or passengers in the vehicle. The environmental information may come from various devices and services installed by the vehicle manufacturer, as well as from various devices and services introduced to the vehicle by occupants of the vehicle, either directly or by systems serving as proxies for other off-board systems.

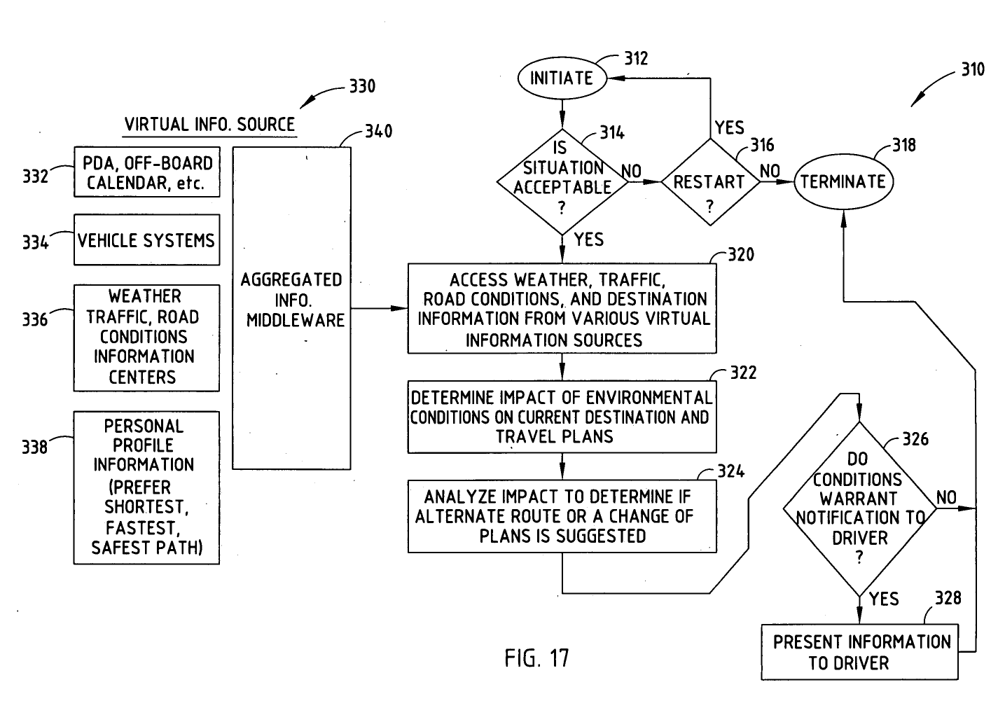

The environmental context advisor 300 may be employed by any of a number of vehicle applications. An example of a vehicle application employing the environmental context advisor is the navigation routine 310 illustrated in FIG. 17. The navigation routine 310 is initiated in step 312 and proceeds to decision step 314 to determine whether the current situation is acceptable to generate a navigation route. If the current situation is not acceptable, navigation routine 310 checks for whether the vehicle is restarted in decision step 316. If the vehicle is restarted, routine 310 returns to the beginning at step 312. Absent a vehicle restart, the navigation routine 310 terminates at step 318.

If the situation is determined to be acceptable in decision step 314, navigation routine 310 proceeds to step 320 to access weather, traffic, road conditions, destination information and other environmental information from various environmental virtual information sources.

The virtual information sources 330 may include any of a number of sources including consumer devices 332, such as a PDA or off-board calendar, vehicle systems 334, weather traffic, road conditions information centers 336, and personal profile information 338. The virtual information source 330 may include aggregated information middlewear to gather the environmental-related information.

With access to the environmental information, the navigation routine 310 determines the impact of the environmental conditions on current destinations and travel plans in step 322. This step 322 may include evaluating whether any of road construction and atmospheric weather conditions require a change of travel plans or scheduling. In step 324, navigation routine 310 analyzes the impact to determine if an alternative route or other change of plans is suggested. In decision step 322, routine 310 determines whether the determined conditions warrant notification to the driver and, if so, presents this information to the driver in step 328. Otherwise, the routine 310 is terminated in step 318. By presenting the information to the driver, the driver is automatically informed as to alternative navigation routes by analyzing the available environmental information provided by the environmental context advisor. In addition to providing alternative routes, the navigation routine 310 may further use monitored weather and road conditions to adjust the estimated time of arrival data, to apply an alternative routine to use well-maintained roads, or to warn the driver of hazardous conditions that may be ahead.

It should also be appreciated that instead of storing the environmental information in memory, the environmental context advisor may store address pointers in memory to access the source of the information so that other devices in the vehicle may be pointed (linked) to the devices that make the environmental information available. It should be appreciated that the environmental context advisor may easily store static information in memory. However, dynamic information may change and, thus, may need to be frequently updated. Accordingly, the environmental context advisor may store the address pointers that point to the location of the dynamic information, such that the environmental context advisor does not have to use processing capability to quickly update this information.

Accordingly, the context advisors of the present invention advantageously integrate information available both onboard and off-board the vehicle to enhance the vehicle driving experience. The context advisors efficiently keep track of the vehicle devices, the personal information, and the environmental conditions in an integrated system to allow various devices on the vehicle to access this information and make more intelligent decisions. Thus, a more efficient and enhanced driving experience may be realized.

It will be understood by those who practice the invention and those skilled in the art, that various modifications and improvements may be made to the invention without departing from the spirit of the disclosed concept. The scope of protection afforded is to be determined by the claims and by the breadth of interpretation allowed by law.

The invention claimed is:

1. A system for providing environmental context information for use with onboard vehicle devices, said system comprising:
an input for accessing and receiving context information;
an identifier for identifying context information related to the environment as environmental context information;
a data storage device having memory for storing the identified environmental context information;
an interface for communicating the data storage device with a plurality of onboard vehicle devices; and
an agent for downloading environmental context information to one or more of the vehicle devices.

2. The system as defined in claim 1, wherein the stored environmental context information comprises an address pointer that indicate the source of the environmental context information.

3. The system as defined in claim 1, wherein the input receives the environmental context information from at least one of an off-board service provider and a vehicle centric system.

4. The system as defined in claim 1, wherein the interface comprises a wireless interface.

5. The system as defined in claim 1, wherein the plurality of vehicle devices comprises a vehicle control module and a navigation device.

6. The system as defined in claim 1, wherein the environmental context information comprises weather information.

7. The system as defined in claim 1, wherein the environmental context information comprises vehicle travel condition information.

8. The system as defined in claim 1, wherein the data storage device is portable.

9. A method of providing environmental context information for use with onboard vehicle devices, said method comprising the steps of:
monitoring information from one or more sources;
identifying information related to the environment as environmental context information;
storing the identified environmental context information in memory;
communicating with an onboard vehicle device; and
downloading at least some of the stored environmental context information to the vehicle device.

10. The method as defined in claim 9, wherein the step of storing the identified environmental context information comprises storing in memory an address pointer indicative of the source of the environmental context information.

11. The method as defined in claim 9, wherein the step of monitoring information from one or more sources comprises monitoring the information from at least one of an off-board service provider and a vehicle centric system.

12. The method as defined in claim 9, wherein the step of communicating with an onboard vehicle device comprises communicating with a plurality of devices comprising a vehicle control module and a navigation device.

13. The method as defined in claim 9, wherein the environmental context information comprises weather information.

14. The method as defined in claim 9, wherein the environmental context information comprises vehicle travel condition information.

15. The method as defined in claim 9, wherein the step of communicating with the onboard vehicle device comprises wireless communication.

16. The method as defined in claim 9 further comprising the step of transporting the memory as a portable memory device.
